(19) United States
(12) Patent Application Publication
(10) Pub. No.: US 2016/0147590 A1
(43) Pub. Date: May 26, 2016

(54) DETERMINE MALFUNCTION STATE OF POWER SUPPLY MODULE

(71) Applicant: HEWLETT-PACKARD DEVELOPMENT COMPANY, L.P., Houston, TX (US)

(72) Inventors: Daniel Humphrey, Cypress, TX (US); Michael G Waters, Houston, TX (US); Mohamed Amin Bemat, Cypress, TX (US)

(21) Appl. No.: 14/905,803

(22) PCT Filed: Jul. 17, 2013
(86) PCT No.: PCT/US2013/050907

§ 371 Date: Jan. 16, 2016

(51) Int. Cl. G06F 11/07

(52) U.S. Cl. CPC G06F 11/0772; G06F 11/0706; G06F 11/0751

(57) ABSTRACT

A method and system including a power supply module. The method and system determine whether the power supply module is in a malfunction state.

### BACKGROUND

Server systems include servers and power supply modules to provide power to the servers. Periodically, events occur which result in a server not receiving power from a respective power supply module resulting in the respective power supply module being replaced.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a server system according to an example.

FIG. 2 is a schematic view of the server system of FIG. 1 according to an example.

FIG. 3 is a bock diagram of the power supply module of FIG. 1 according to an example.

FIG. 4 is a flowchart illustrating a method of determining whether a power supply module is in a malfunction state according to an example.

FIG. 5 is a flowchart illustrating a method of determining whether a power supply module is in a malfunction state according to an example.

FIG. 6 is a block diagram illustrating a computing device including a processor and a non-transitory, computer-readable storage medium to store instructions to determine whether a power supply module is in a malfunction state according to an example.

### DETAILED DESCRIPTION

Server systems respond to requests across a computer network to provide, or help provide, a network service. The server system may operate within a client-server architecture and run computer programs to serve requests and/or perform some task on behalf of clients. Typical computing servers are database servers, file servers, mail servers, print servers, web servers, gaming servers, application servers, or other servers. Server systems may include servers and power supply modules to provide power to the servers. Periodically, events occur which result in a server not receiving power from a respective power supply module resulting in the respective power supply module being replaced, However, on many occasions the power supply module may not be defective and conditions external to the power supply module such as the server may be the reason for power not being received. Thus, an unnecessary amount of service time and cost may be incurred by replacing and/or sending in for service a properly functioning power supply module.

In examples, a server system includes a server, a server fault module, and a power supply module. The server fault module may store information corresponding to whether a server fault condition of the server system exists. The power supply module may provide power to the server. The power supply module may include a supply fault module and a supply controller. The supply fault module may store information corresponding to whether a supply fault condition of the power supply module exists. The supply controller may communicate with at least one of the server fault module and the supply fault module to determine whether the power supply module is in a malfunction state. Further, in some examples, a properly functioning power supply module may be able to provide an output power when input power is applied to it, even when the power supply module is uninstalled from the server system. Thus, the power supply module may be tested in a quick manner with minimal downtime. Consequently, false replacements and/or returns back in the field may be reduced. Accordingly, failure analysis costs may be greatly reduced and overall reliability numbers significantly increased.

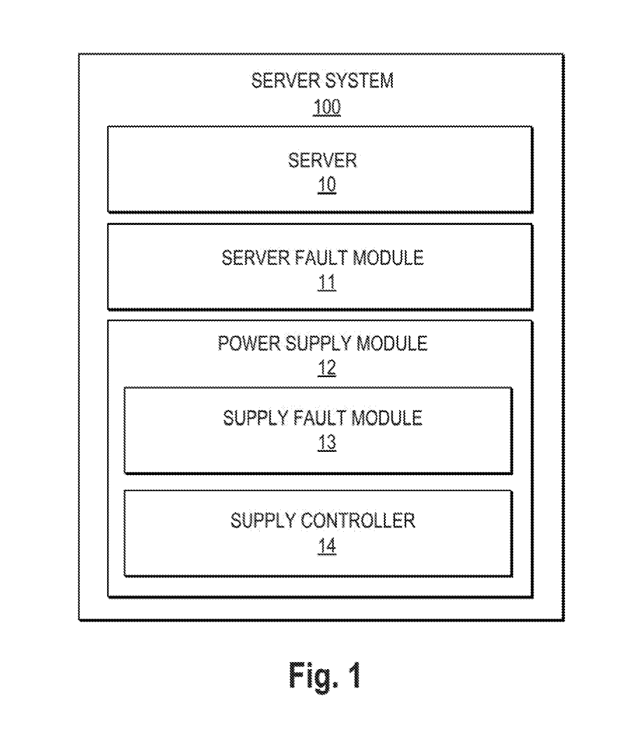

FIG. 1 is a block diagram illustrating a server system according to an example. Referring to FIG. 1, in some examples, a server system 100 includes a server 10, a server fault module 11, and a power supply module 12. The server 10 may perform a task on behalf of a client. For example, the server may include machine readable instructions and hardware that responds to requests across a computer network to provide, or help to provide, a network service. The server fault module 11 may store information corresponding to whether a server fault condition of the server system 100 exists. The power supply module 12 may provide power to the server 10. The power supply module 12 may include a supply fault module 13 and a supply controller 14. The supply fault module 13 may store information corresponding to whether a supply fault condition of the power supply module 12 exists. The supply controller 14 may communicate with at least one of the server fault module 11 and the supply fault module 13 to determine whether the power supply module 12 is in a malfunction state. For example, the server fault module 11 and the supply fault module 13 may store present and/or previous information indicative of respective fault conditions.

Referring to FIG. 1, in some examples, the supply controller 14, the supply fault module 13, and the server fault module 11 may be implemented in hardware, software including firmware, or combinations thereof. For example, the firmware may be stored in memory and executed by a suitable instruction-execution system, If implemented in hardware, as in an alternative example, the supply controller 14, the supply fault module 13, and the server fault module 11 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In some examples, the supply controller 14, the supply fault module 13, and the server fault module 11 may be implemented in a combination of software and data executed and stored under the control of a computing device.

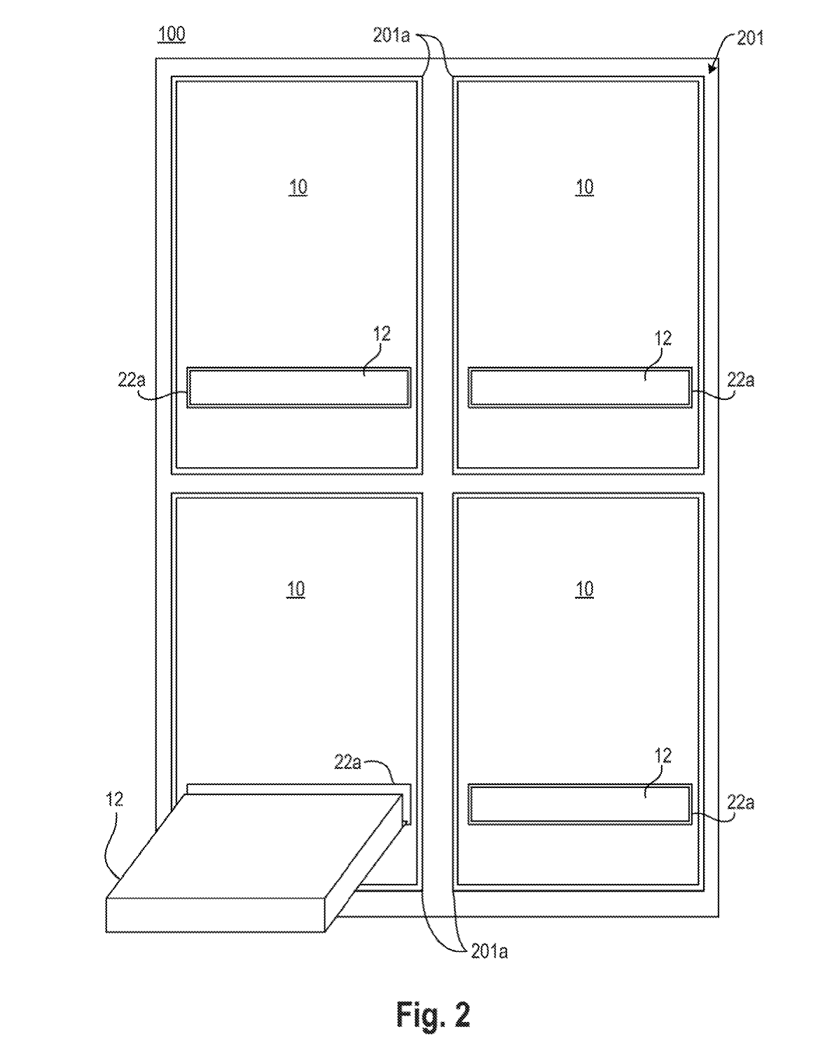

FIG. 2 is a schematic view of the server system of FIG. 1 according to an example. Referring to FIG. 2, in some examples, the server system 100 may include a single server 10 and a single power supply module 12. Alternatively, the server system 100 may include a plurality of servers 10 and a plurality of power supply modules 12. For example, the server system 100 may include a server rack structure 201 including a plurality of server bays 201a, and a plurality of servers 10 disposed in the server bays 201a. The servers 10 may include power supply bays 22a for the power supply modules 12 to be disposed therein. For example, the power supply modules 12 may removably fit into the power supply bays 22a of the server system 100. Alternatively. the power supply modules 12 may be disposed directly in other bays, and the like, of the server rack structure 201.

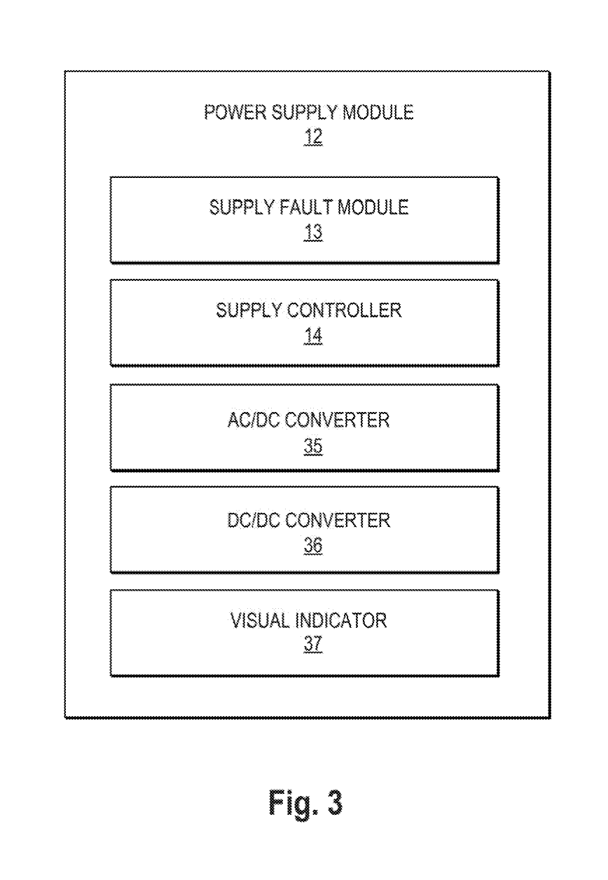

FIG. 3 is a block diagram of the power supply module of FIG. 1 according to an example. Referring to FIG. 3, in some examples, the power supply module 12 may include the supply fault module 13 and the supply controller 14 as previously discussed with respect to FIG. 1. Referring to FIG. 3, in some examples, the power supply module 12 may also include an alternating current to direct current (AC/DC) converter 35, a direct current to direct current (DC/DC) converter 36, and a visual indicator 37. The AC/DC converter 35 may convert an alternating current to a direct current. The DC/DC converter 36 may receive the direct current from the AC/DC converter 35 and provide at least one of a main power and a standby power to the server 10. The visual indicator 37 may indicate whether the power supply module 12 is in the malfunction state. For example, the visual indicator 37 may be a light and/or a display, to inform a user that the power supply module 12 is in the malfunction state. In some examples, the supply controller 14 may determine that the power supply module 12 is in the malfunction state and communicate it to the visual indicator 37.

Referring to FIG. 3, in some examples, the supply controller 14 may determine whether the power supply module 12 is in the malfunction state in response to identification that the supply fault condition exists based on the information of the power supply module 12 stored in the supply fault module 13. In some examples, the supply controller 14 may determine that the power supply module 12 is in the malfunction state by confirming that the power supply module 12 receives input power within a first predetermined range, the power supply module 12 did not receive an external overload based on a condition outside of the power supply module 12, and a fault did not exist due to a server condition based on the information stored in the server fault module.

For example, the server fault module 11 and the supply fault module 13 may store present and/or previous information indicative of respective fault conditions. Additionally, in some examples, the output power of the power supply module 12 may be tested, even when the power supply module 12 is uninstalled from the server system 100, In some examples, the supply controller 14 may determine that the power supply module 12 is in the malfunction state in response to at least one of a confirmation that an output of the power supply module 12 is outside of a predetermined second range and the power supply module 12 was previously in the malfunction state.

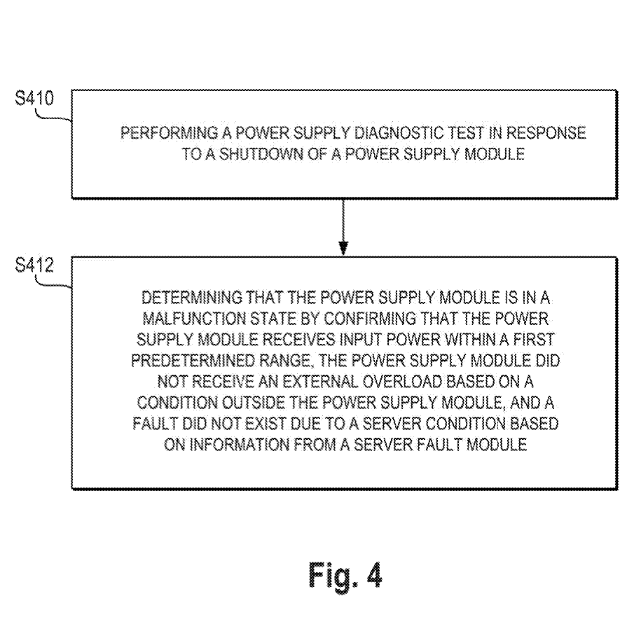

FIG. 4 is a flowchart illustrating a method of determining whether a power supply module is in a malfunction state according to an example. Referring to FIG. 4, in block S410, a power supply diagnostic test is performed in response to a shutdown of the power supply module. For example, the server fault module and the supply fault module may store present and/or previous information indicative of respective fault conditions. In block S412, a power supply module is determined to be in a malfunction state by confirming that the power supply module receives input power within a first predetermined range, the power supply module did not receive an external overload based on a condition outside of the power supply module, and a fault did not exist due to a server condition based on information from a server fault module. For example, the server fault module and the supply fault module may store present and/or previous information indicative of respective fault conditions.

In some examples, a determination is made that the power supply module is in the malfunction state based on a confirmation that the power supply module receives an input within the first predetermined range in response to performing the power supply diagnostic test. In some examples, a determination is made that the power supply module is not in the malfunction state based on a confirmation that the power supply module did receive the external overload based on an electrical short of a component of one of the server and a parallel power supply module in response to performing the power supply diagnostic test. In some examples, a determination is made that the power supply module is not in the malfunction state based on a confirmation that the fault did exist due to a failure of a cooling fan external to and to cool the power supply module in response to performing the power supply diagnostic test.

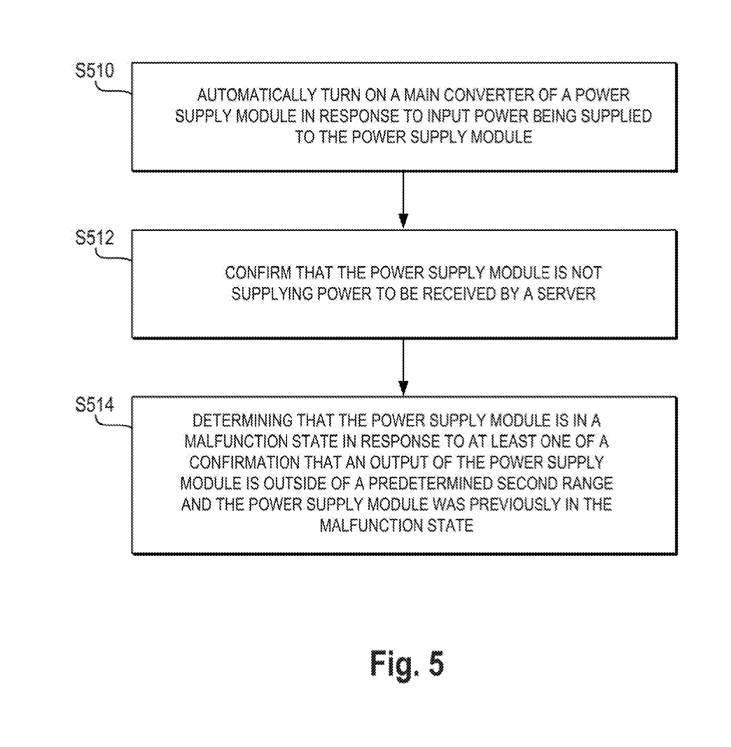

FIG. 5 is a flowchart illustrating a method of determining whether a power supply module is in a malfunction state according to an example. Referring to FIG. 5, in block S510, a main converter of the power supply module is automatically turned on in response to input power being supplied to the power supply module. For example, the main converter of the power supply module may be turned on to produce a standby power in response to a valid input to the power supply module. In some examples, the input power may be alternating current. In block S512, a confirmation is made that the power supply module is not supplying power to be received by a server. For example, a respective power signal may be confirmed as not being provided from the power supply module through an interface connector to the server.

In block S514, the power supply module is determined to be in the malfunction state in response to at least one of a confirmation that an output of the power supply module is outside of a predetermined second range and the power supply module was previously in the malfunction state. For example, whether the output of the power supply module is outside of the predetermined second range is determined and, if so, a determination is made that the power supply module is in the malfunction state. Alternatively, if the output of the power supply module is not outside of the predetermined second range, a determination is made whether the power supply module was previously in the malfunction state and, if so, a determination is made that the power supply module is in the malfunction state. Alternatively, if the power supply module was not previously in the malfunction state, a determination is made that that the power supply module is not in the malfunction state. For example, the server fault module and/or the supply fault module may store information indicative of whether the power supply module was previously in the malfunction state.

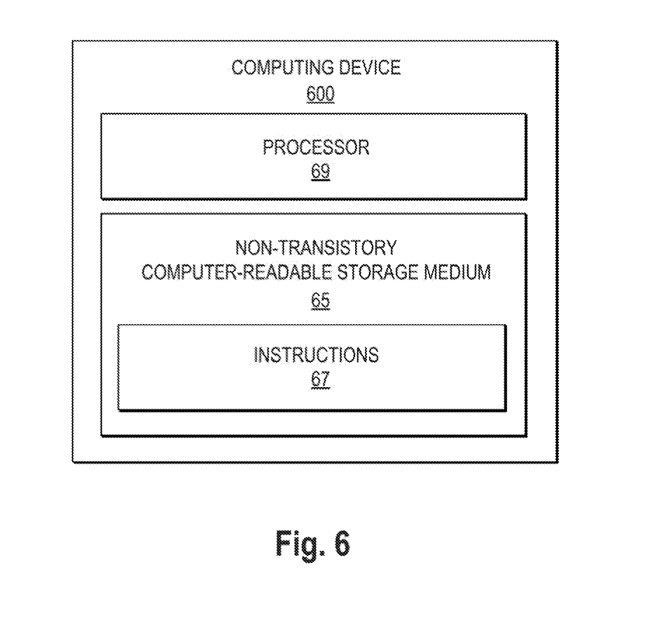

FIG. 6 is a block diagram illustrating a computing device including a processor and a non-transitory, computer-readable storage medium to store instructions to determine whether a power supply module is in a malfunction state according to an example. Referring to FIG. 6, in some examples, the non-transitory, computer-readable storage medium 65 may be included in a computing device 600 such as server system and/or a power supply module to store instructions to determine whether a power supply module is in a malfunction state. In some examples, the non-transitory, computer-readable storage medium 65 may be implemented in whole or in part as instructions 67 such as computer-implemented instructions stored in the computing device locally or remotely, for example, in a server or a host computing device.

Referring to FIG. 6, in some examples, the non -transitory, computer-readable storage medium 65 may correspond to a storage device that stores instructions 67, such as computer-implemented instructions and/or programming code, and the like. For example, the non-transitory, computer-readable storage medium 65 may include a non-volatile memory, a volatile memory, and/or a storage device. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM).

Referring to FIG. 6, examples of storage devices include, but are not limited to, hard disk drives, compact disc drives, digital versatile disc drives, optical drives, and flash memory devices. In some examples, the non-transitory, computer-readable storage medium 65 may even be paper or another suitable medium upon which the instructions 67 are printed, as the instructions 67 can be electronically captured, via, for instance, optical scanning of the paper or other medium, then compiled, interpreted or otherwise processed in a single manner, if necessary, and then stored therein. A processor 69 generally retrieves and executes the instructions 67 stored in the non-transitory, computer-readable storage medium 65, for example, to operate a computing device 600 such as a server system and/or power supply module to store instructions to determine whether a power supply module is in a malfunction state in accordance with an example. In an example, the non-transitory, computer-readable storage medium 65 can be accessed by the processor 69.

It is to be understood that the flowcharts of FIGS. 4 and 5 illustrate architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowcharts of FIGS. 4 and 5 illustrate a specific order of execution, the order of execution may differ from that which is depicted. For example, the order of execution of two or more blocks may be rearranged relative to the order illustrated. Also, two or more blocks illustrated in succession in FIGS. 4 and 5 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A server system, comprising:
a server;
a server fault module to store information corresponding to whether a server fault condition of the server system exists; and
a power supply module to provide power to the server, the power supply module including a supply fault module and a supply controller;
the supply fault module to store information corresponding to whether a supply fault condition of the power supply module exists; and
the supply controller to communicate with at least one of the server fault module and the supply fault module to determine whether the power supply module is in a malfunction state.

2. The server system of claim, wherein the power supply module further comprises:
an alternating current to direct current (AC/DC) converter to convert an alternating current to a direct current; and
a direct current to direct current (DC/DC) converter to receive the direct current from the AC/DC converter and provide at least one of a main power and a standby power to the server.

3. The server system of claim 2, wherein the DC/DC converter is configured to provide the main power and the standby power to the server.

4. The server system of claim 1, wherein the power supply module further comprises:
a visual indicator to indicate whether the power supply module is in the malfunction state.

5. The server system of claim 1, wherein the supply controller is configured to determine whether the power supply module is in the malfunction state in response to identification that the supply fault condition exists based on the information of the power supply module stored in the supply fault module.

6. The server system of claim 1, wherein the supply controller to communicate with at least one of the server fault module and the supply fault module to determine whether the power supply module is in a malfunction state further comprises:
the supply controller to determine that the power supply module is in the malfunction state by confirming that the power supply module receives input power within a first predetermined range, the power supply module did not receive an external overload based on a condition outside of the power supply module, and a fault did not exist due to a server condition based on the information stored in the server fault module.

7. The server system of claim 1, wherein the supply controller to communicate with at least one of the server fault module and the supply fault module to determine whether the power supply module is in a malfunction state further comprises:
the supply controller to determine that the power supply module is in the malfunction state in response to at least one of confirmation that an output of the power supply module is outside of a predetermined second range and the power supply module was previously in the malfunction state.

8. A method of determining whether a power supply module is in a malfunction state, the method comprising:
performing a power supply diagnostic test in response to a shutdown of the power supply module; and
determining that a power supply module is in a malfunction state by confirming that the power supply module receives input power within a first predetermined range, the power supply module did not receive an external overload based on a condition outside of the power supply module, and a fault did not exist due to a server condition based on information from a server fault module.

9. The method of claim 8, wherein a determination is made that the power supply module is in the malfunction state based on a confirmation that the power supply module receives an input within the first predetermined range in response to the performing the power supply diagnostic test.

10. The method of claim 8, wherein a determination is made that the power supply module is not in the malfunction state based on a confirmation that the power supply module did receive the external overload based on an electrical short of a component of one of the server and a parallel power supply module in response to the performing the power supply diagnostic test.

11. The method of claim 8, wherein a determination is made that the power supply module is not in the malfunction state based on a confirmation that the fault did exist due to a failure of a cooling fan external to and to cool the power supply module in response to the performing the power supply diagnostic test.

12. A non-transitory computer-readable storage medium having computer executable instructions stored thereon to determine whether a power supply module is in a malfunction state, the instructions are executable by a processor to:
automatically turn on a main converter of the power supply module n response to input power being supplied to the power supply module:
confirm that the power supply module is not supplying power to be received by a server; and
determine that the power supply module is in the malfunction state in response to at least one of confirmation that an output of the power supply module is outside of a predetermined second range and the power supply module was previously in the malfunction state.

13. The non-transitory computer-readable storage medium of claim 12, wherein the automatically turn on a main converter of the power supply module in response to input power being supplied to the power supply module further comprises:
turn on the main converter of the power supply module to produce a standby power in response to a valid input to the power supply module.

14. The non-transitory computer-readable storage medium of claim 12, wherein the confirm that the power supply module is not supplying power to a server further comprises:
confirm that a respective power signal is not being provided from the power supply module through an interface connector to the server.

15. The non-transitory computer-readable storage medium of claim 12, wherein the determine that the power supply module is in a malfunction state further comprises:
determine whether the output of the power supply module is outside of the predetermined second range and:
if so, determine that the power supply module is in the malfunction state; and
if not, determine whether the power supply module was previously in the malfunction state and:
if the power supply module was previously in the malfunction state, determine that the power supply module is in the malfunction state; and
if the power supply module was not previously in the malfunction state, determine that the power supply module is not in the malfunction state.
